(19) United States
(12) Patent Application Publication
(10) Pub. No.: US 2009/0109513 A1
(43) Pub. Date: Apr. 30, 2009

(54) HEAD MOUNTED DISPLAY HAVING ELECTROWETTING OPTICAL REFLECTING SURFACE

(75) Inventor: Joseph Bostaph, Chandler, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/930,890

(22) Filed: Oct. 31, 2007

(51) Int. Cl. G02B 26/02; G06K 9/36

(52) U.S. Cl. 359/228; 382/289

(57) ABSTRACT

A method and apparatus is provided for aligning the two images (528) of a binocular eyewear display (500, 600) with respect to their vertical and horizontal alignment, and magnification. The method for aligning images comprise generating a signal from a display modification system (718) based on stored values indicative of misalignment of the binocular eyewear display (500, 600); and adjusting, in accordance with the signal, an image (528, 1052, 1152, 1252) to be displayed. The reflection angle of one or more electrowetting devices (708, 1000, 1300) is modified to move the image in an X and/or Y direction, or to focus the image.

### FIELD

The present invention generally relates to binocular eyewear displays and more particularly to a method and apparatus for aligning the two images of a binocular eyewear display with respect to their vertical and horizontal orientation, and magnification.

### BACKGROUND

Binocular displays include head mounted displays such as glasses and helmet mounted displays wherein a virtual image is presented to each eye. The image, usually created by a microdisplay, for example an LCD screen, may be presented to the eye by means of refractive or reflective optics, for example, through a lens system. Ideally the virtual images presented to each eye are perfectly aligned and the user perceives a single image similar to their perception of real images. If the virtual images are misaligned, the user may experience discomfort, for example, eye strain, headache, and nausea.

Commercial binocular eyewear are aligned mechanically during manufacture and some misalignment is common. Furthermore, misalignment of binocular eyewear may occur during use due to physical shock or exposure to temperature or humidity. Although there are no widely accepted standards for alignment, there have been several studies to determine acceptable values of binocular image alignment. A compilation of the desired alignment tolerances to avoid user discomfort is as shown in the following table as disclosed in Melzer & Moffitt, Head Mounted Displays—Designing for the User, New York: McGraw-Hill, 1997 (ISBN 0070418195).

| | REQUIREMENT | REQUIREMENT |
|---|---|---|
| PARAMETER | (see-through) | (immersive) |
| VERTICAL | 3 minutes of arc | 5 minutes of arc |
| HORIZONTAL | 3 minutes divergent; | ¼ diopter of focus |
| | 8 minutes convergent | distance |
| IMAGE ROTATION | 1 degree | 1 degree |
| MAGNIFICATION | 1 percent | 1 percent |

Although vendors of commercial eyewear displays are aware of the need for binocular image alignment, products today are not shipped with any alignment specifications.

Systems have been disclosed wherein a user of the binocular eyewear may take corrective steps to bring the misalignment within certain tolerances. See for example, in US 2003/0184860, the user operates a device to move a dot until it is aligned with another dot, and in WO 2006/058188, the user adjusts first and second display panels until images of display panel indicia shown on the viewing screen are located relative to baseline indicia.

However, users of systems requiring user intervention to properly align the system may find it burdensome to perform such intervention, especially when it may be required each time the system is activated.

Accordingly, it is desirable to provide a method and apparatus for aligning the two images of a binocular eyewear display with respect to their vertical and horizontal orientation, and magnification. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

Embodiments of the present invention will hereinafter be described in conjunction with the following drawing figures, wherein like numerals denote like elements, and

FIG. 1 is a projected image free from misalignment;

FIG. 2 is a projected image having horizontal misalignment;

FIG. 3 is a projected image having vertical misalignment;

FIG. 4 is a projected image having magnification misalignment;

FIG. 5 is a cross section of a known electrowetting system;

FIG. 6 is a cross section of a known electrowetting system of FIG. 5 having a variable voltage applied;

FIGS. 7-9 are top schematic views of three exemplary embodiments using the electrowetting system of FIG. 6;

FIG. 10 is a top cross section of another known electrowetting system;

FIGS. 11-12 are top cross sections of the electrowetting system of FIG. 10 with voltages applied;

FIGS. 13-14 are cross sections of yet another known electrowetting system; and

FIG. 15 is a top schematical view of an exemplary embodiment using the electrowetting system of FIG. 13-14.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

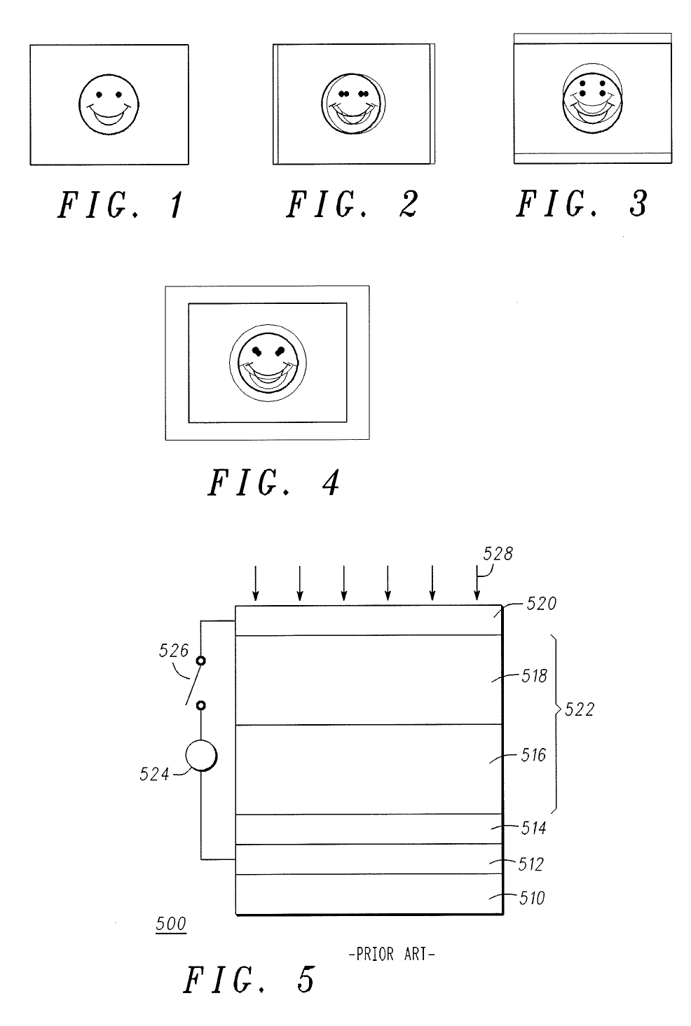

Commercial binocular eyewear is aligned mechanically at manufacture and some misalignment is common. Alignment refers to the image presented to one eye being aligned with the image presented to the other eye. The illustration shown in FIG. 1 is representative of an aligned image. Types of image misalignment that may be encountered by the binocular display device include horizontal misalignment (FIG. 2), vertical misalignment (FIG. 3), and magnification (focusing) misalignment (FIG. 4). This image misalignment can be corrected either by mechanical or electronic means.

Mechanical means of alignment may involve mechanical adjustment of either the image source, for example a microdisplay, or by adjustment of optical components between the image source and the eye, for example a lens. Because of the very small image alignment tolerances, the required mechanical adjustment may be prohibitively expensive to execute during or after manufacture of the device. The mechanical precision required may be on the order of 1 micron to 1 mm depending on the mechanism used to make the adjustment. One limitation is that it can be difficult or expensive to realign the images after the device is manufactured because it may require disassembly and of the eyewear display and for some components to be debonded. Also, it is not possible to correct for misalignment that may result from changes in temperature at which the device operates.

Horizontal or vertical image alignment of the image presented to both eyes is accomplished by shifting pixels in one or both of the images presented by the image generating devices 704. In the chart below, it is shown that by shifting an image by one pixel shifts results in an angular change of 1.5 to 3.75 minutes of arc for the selected resolutions. This enables the very tight vertical and horizontal image alignment tolerances to be met simply through the electronic image adjustment. This chart uses values for a typical eyewear display with a 25 degree diagonal field of view with a 4:3 aspect ratio for the image.

| | | One pixel shift | |
|---|---|---|---|
| Field of view | Resolution | corresponds to: | Alignment tolerance |
| 15 degrees | QVGA (240 vertical pixels) | 3.75 minutes | 3 minutes (see-through) |
| vertical | VGA (480 vertical pixels) | 1.875 minutes | 5 minutes (immersive) |
| | SVGA (600 vertical pixels) | 1.5 minutes | |
| 20 degrees | QVGA (320 horizontal pixels) | 3.75 minutes | 3 to 8 minutes (see |
| horizontal | VGA (640 horizontal pixels) | 1.875 minutes | through |
| | SVGA (800 horizontal pixels) | 1.5 minutes | |

Although adjustments for vertical and horizontal image alignment can be accomplished by shifting the image on a microdisplay, obtaining proper alignment with respect to rotation and magnification may be a more complex manipulation of the initial image. A microcomputer may be required to calculate the corrected image.

By measuring the optical misalignment, e.g., at the factory or subsequently at a sales or repair facility, and storing misalignment parameters such as vertical, horizontal, rotation, and magnification, in memory integral to the eyewear, correction may be made automatically without user interaction to bring the alignment within desired limits. A first image is presented to a first eye and a second image is presented to a second eye. A microcomputer may adjust at least one of the first and second images, e.g., by shifting or rotating the image, in accordance with the stored parameters. Additionally, the optical misalignment may be measured at a plurality of temperatures and humidity with the misalignment at each temperature and humidity stored. Subsequently, the misalignment at a current temperature and/or humidity may be adjusted in accordance with the stored values.

In a typical binocular optical system employed for head mounted displays, such as a see through optical system, one or more reflecting surfaces made of a solid inserted material, e.g., a mirror, are used to redirect the internally directed image. Several exemplary embodiments are described herein of an apparatus and method for redirecting and aligning this internally directed image with electrowetting technology that selectively redirects the image in an X and Y direction and selectively focuses the image. This method allows for alignment without complex hardware alignment systems.

A low cost reflective display technology, electrowetting light valves, may be used to produce an angled reflective surface. Typical electrowetting devices use a DC, or low frequency, voltage to change the wetting properties of a drop of oil in water in relation to a hydrophobic surface, thereby changing the position of the oil. The amount of the movement of the oil, and therefore the angle of reflection, depends on the magnitude of the applied voltage. Thus, a slight change in the angle of reflection may be accomplished by a change in the magnitude of the voltage.

FIG. 5 is partial cross section of a known electrowetting display 500 of a single stack comprising a transparent electrode 512 deposited on a substrate 510. A transparent hydrophobic insulator 514 is formed on the electrode 512 for supporting the combination of oil 516 and water 518. A transparent electrode 520 is formed above and for containing the water 518 and oil 516 in a cavity 522. A DC/low frequency voltage source 524 is coupled between the electrodes 512 and 520, and is selectively applied by closing the switch 526. When the switch 526 is closed and a voltage is applied across the conductors 512 and 520, the oil 516 moves to the side (not shown) as is known in the industry by being displaced against the transparent hydrophobic insulator 516 by the water 518.

In operation, without voltage applied, the layer of oil 516 is located in the optical path, and any applied image 528 is reflected back towards where it originated (FIG. 5). By applying a DC, or low frequency to the device (FIG. 6), voltage to the layers (typically<40 V), the oil 516 moves toward the side of each cell, thereby changing the angle of reflection. Incident light then bounces off the reflective surface in a desired direction. The amount of displacement of the oil is correlated to the applied voltage. Consequently, various angles of reflection are obtained by modulating the applied voltage level. FIG. 6 illustrates the oil 516 assuming four positions. By the application of a certain voltage, for example, by adjusting a rheostat 630, the surface 632 is approximately 45 degrees to its original position (FIG. 5). By the application of a more positive voltage to the electrode 512 the angle increases as shown by the surface 634, and by application of a less positive voltage, the angle decreases as shown by the surface 636. It should be noted that by the application of a negative voltage to the electrode 512 (with respect to the voltage applied to the electrode 520), the disposition of the oil 516 would be more appropriately represented by the surface 638.

The angle of reflection is maintained by continual application of applied voltage. However, the leakage current is tremendously small, and a desired angle of reflection can be maintained for minutes after the voltage source 524 is disconnected. In the illustrated known display, voltage levels can alternatively be applied to the display 500 once to set the desired angle of reflection, and then they are re-applied at intervals (for example, 2 minutes), to refresh the charge.

These electrowetting devices described herein may be fabricated using known lithographic processes as follows. The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

Though various lithography processes, e.g., photolithography, electron beam lithography, and imprint lithography, ink jet printing, may be used to fabricate the light electrowetting device 500, a printing process is preferred. Ink compositions typically comprise four elements: 1) functional element, 2) binder, 3) solvent, and 4) additive. The binder, solvent and additives, together, are commonly referred to as the carrier which is formulated for a specific printing technology e.g. tailored rheology. The function of the carrier is the same for graphic arts and printed electronics: dispersion of functional elements, viscosity and surface tension modification, etc. A variety of printing techniques, for example, Flexo, Gravure, Screen, inkjet may be used. The Halftone method, for example, allows the full color range to be realized in actual printing.

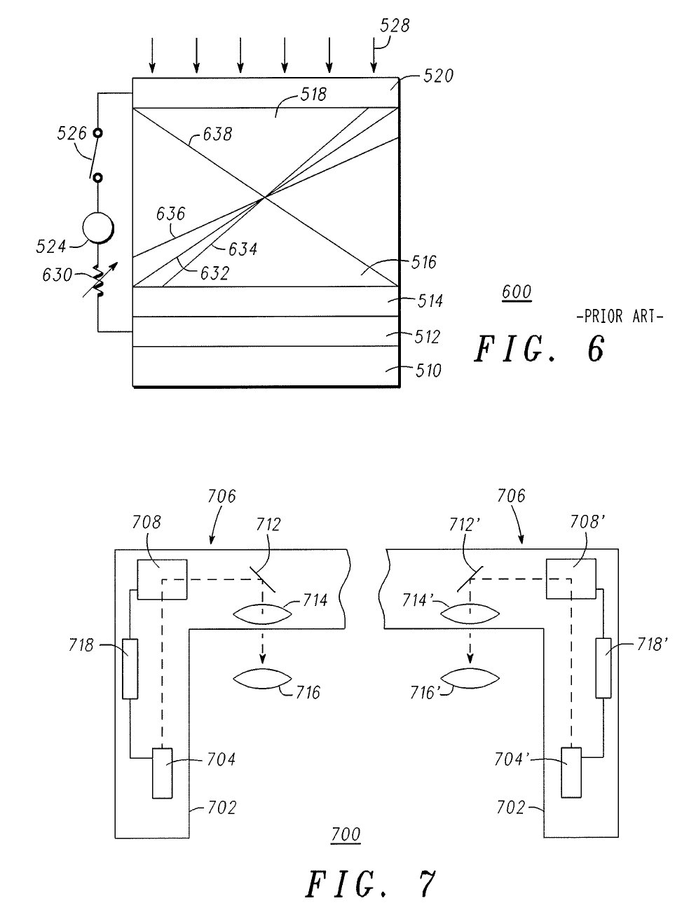

Referring now to FIG. 7, a wearable display, and preferably a head mounted display, is a binocular display device 700 in accordance with an exemplary embodiment comprises a housing 702 including an optical image generating device 704, optics system 706, and an electrowetting device 708. Though only one side of the binocular display device 700 for presenting the image to a single eye may be used, it is understood that a second side for the other eye is preferred. The second side (prime numerals) may be identical to the first side as illustrated in FIG. 7, or it may share a single image generating device 704 wherein the image may be split, for example, and a single microcomputer 718. The remaining exemplary embodiments will illustrate only one side, though it should be understood that two sides are preferred.

The image generating device 704 may, for example, comprise an input (not shown) for wired or wireless coupling or an electronic device for receiving and reading video data from a DVD or the like. The optics system 706 includes a reflective surface 712 and optionally a lens 714 for displaying an image to an eye 716. It should be understood that there are many types of optical systems that may include, for example, mirrors and/or waveguides. It should be understood the present invention should not be limited by the type of image receiving device 704 or the type of optics system 706 described herein.

When an image, which typically would comprise a video stream, is received by the image receiving device 704, it is transmitted to the electrowetting device 708 which reflects the image to the reflective surface 712. The image then proceeds through the lens 714 for viewing.

The microcomputer 718 may be coupled between the image receiving device 704 and the electrowetting device 708 for determining necessary adjustments and for adjusting the voltage applied to the electrowetting device 708 and thereby modifying the angle of reflection. The microcomputer 718 may be integrated into the binocular display device 700 as shown or may reside elsewhere and be coupled electronically to the binocular display device 700. The microcomputer 718 may further include an environmental sensor for sensing, for example, the temperature and/or humidity, and wherein the voltage is adjusted for changes in temperature and/or humidity.

When the binocular display device 700 is fabricated, misalignment parameters are recorded. When an image is to be displayed, the microcomputer 718 retrieves these misalignment parameters and adjusts the voltage applied to the electrowetting device 708 to compensate for the misalignment of the binocular display device 700.

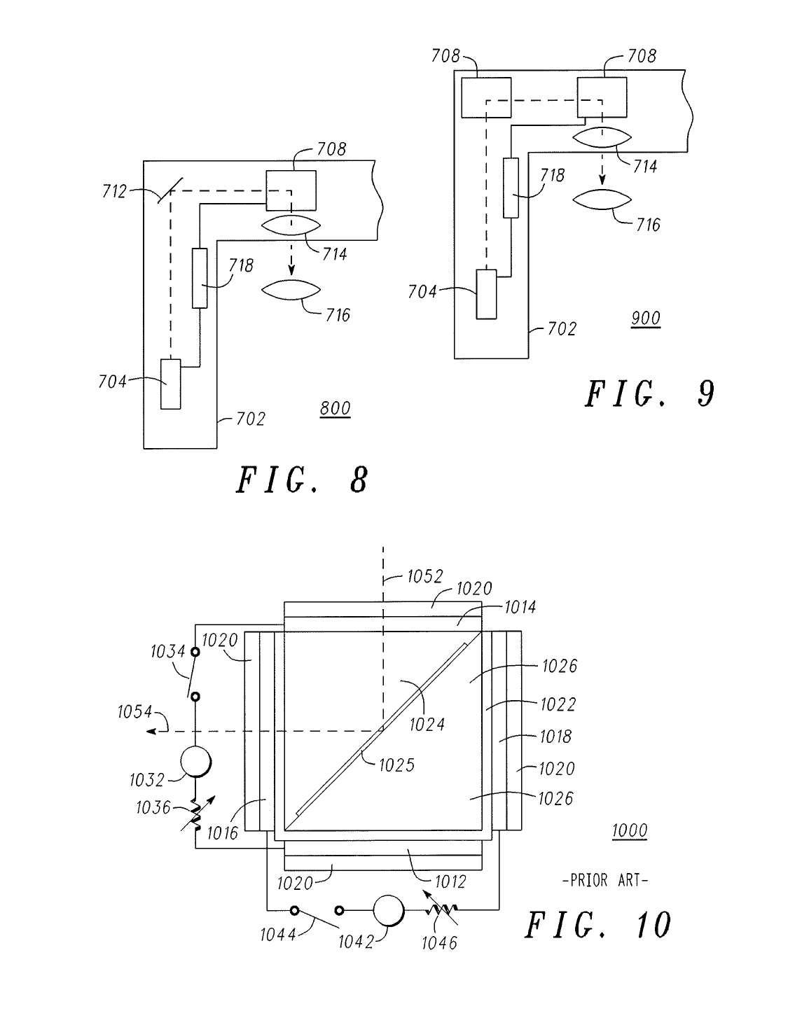

FIG. 8 is an exemplary embodiment of the binocular display device 800 wherein the electrowetting device 708 and the reflective surface 712 have exchanged positions.

While it may be apparent that an electrowetting device described in FIG. 6 used in the exemplary embodiments of FIGS. 7 and 8 would align the image in only one direction, say the X direction, the exemplary embodiment of FIG. 9 aligns the image in both an X and a Y direction. Two of the electrowetting devices 708, one rotated 90 degrees with respect to the other provide the X and Y alignment.

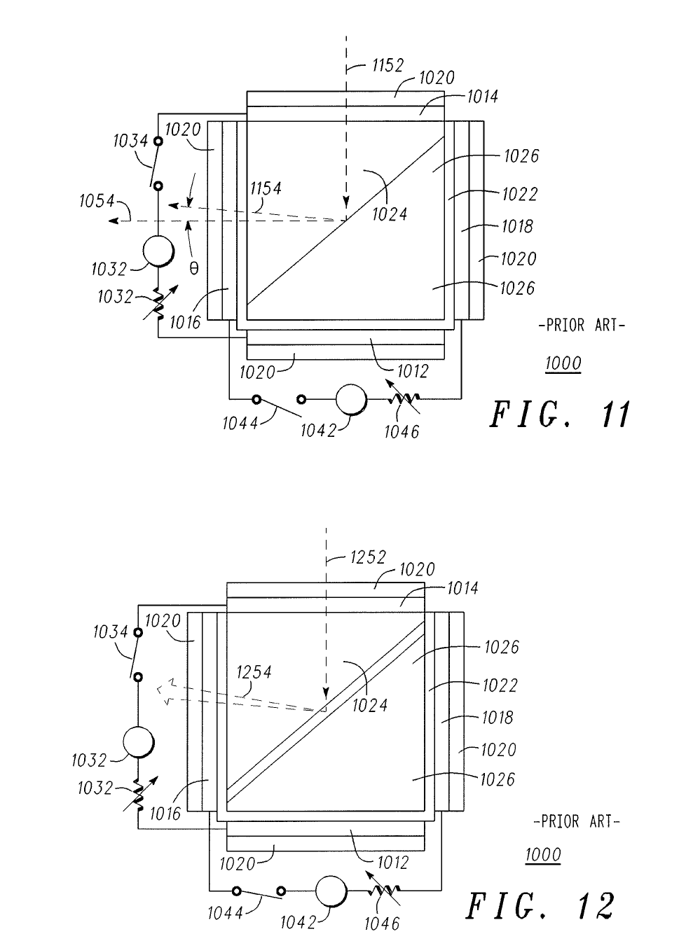

An alternative method to provide alignment in both the X and Y direction would be to employ the electrowetting device shown in FIG. 10 in either of the exemplary embodiments of FIG. 7 or 8. In FIG. 10, a partial cross section of a known electrowetting display 1000 comprising a bottom transparent electrode 1012, a top transparent electrode 1014, and side transparent electrodes 1016, 1018, all deposited on a substrate 1020. A transparent hydrophobic insulator 1022 is formed between the electrodes 1012, 1016, 1018 for supporting the combination of water 1024 and oil 1026. A DC/low frequency voltage source 1032 is coupled between the electrodes 1012 and 1014, and is selectively applied by closing the switch 1034. A rheostat 1036 selectively modifies the magnitude of the applied voltage from the source 1032. Another DC/low frequency voltage source 1042 is coupled between the electrodes 1016 and 1018, and is selectively applied by closing the switch 1044. A rheostat 1046 selectively modifies the magnitude of the applied voltage from the source 1042. When the rheostat 1032 is adjusted and a voltage applied across the conductors 1012 and 1014 is changed, the oil 1026 displacement against the transparent hydrophobic insulator 1022 by the water 1024 is modified as shown in FIG. 11, resulting in an alignment in the X direction. When the rheostat 1046 is adjusted and a voltage applied across the conductors 1016 and 1018 is changed, the oil 1026 displacement against the transparent hydrophobic insulator 1022 by the water 1024 is modified as shown in FIG. 12, resulting in an alignment in the Y direction as well as the X direction. For example, in FIG. 10, the image 1052 enters the electrowetting device 1000 and exits as a reflected image 1054. In FIG. 11, with the applied voltage 1042 adjusted, the entering image 1152 is departs the electrowetting device 1000 as a reflected image 1154 at an angle O in the X direction (in an upward direction as illustrated) from the image 1054. In FIG. 12, with the applied voltage 1032 adjusted, the entering image 1252 is departs the electrowetting device 1000 as a reflected image 1254 at an angle O in the X direction (in an upward direction as illustrated) and in a Y direction (illustrated as an arrow that increases in size) from the image 1054. A side 1027 of the oil 1026 is shown to illustrate that the oil 1026 is tilted away from the viewer's point of view. Additionally, a reflecting material 1025 may be optionally inserted between the water 1024 and oil 1026 solution to assist in reflecting the image. The reflecting material 1025 would be freestanding and move within the electrowetting system 1000 according to the supplied voltage 1032 to the system, and may comprise any reflecting surface such as a polymer having a reflecting metal applied thereto.

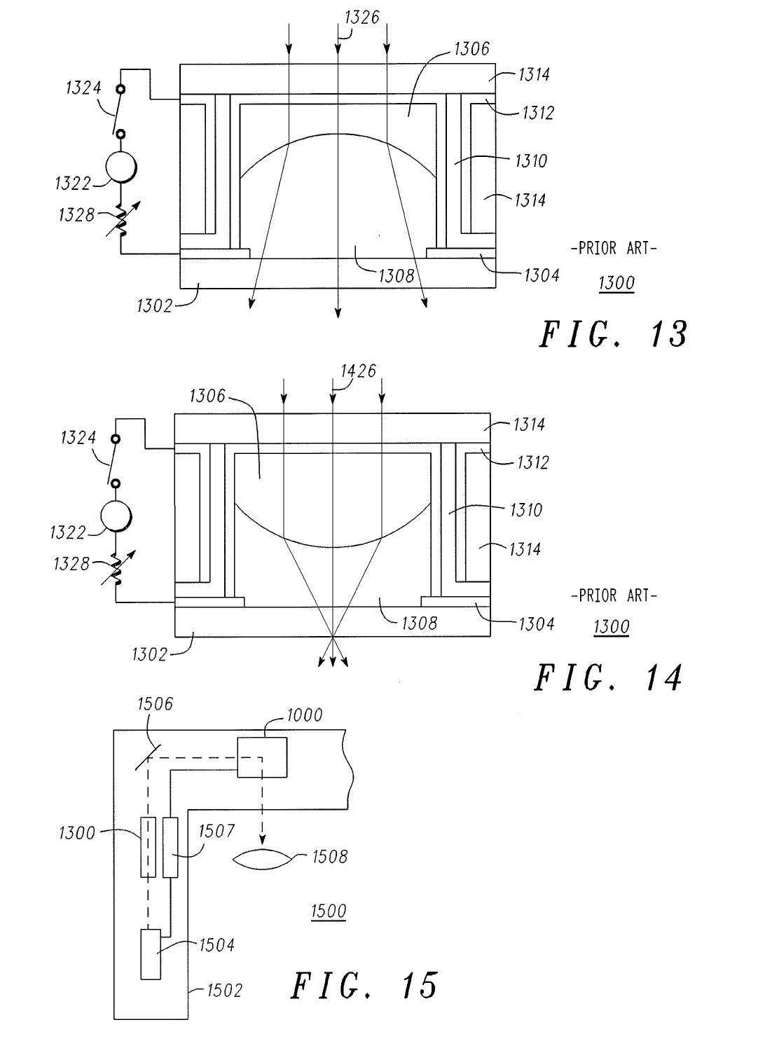

Referring to FIGS. 13 and 14, an electrowetting device 1300, shown in cross section, may also be used to change the focus of an image. A transparent conductive material 1304 is formed on a transparent substrate 1302 and around a cavity above the substrate 1302 for holding water 1306 and a drop of oil 1308. A dielectric material 1310 is disposed between the conductive material 1304 and a second conductive material 1312. Another substrate 1314 is formed thereover and on the sides for support. A DC/low frequency voltage source 1322 is coupled between the electrodes 1304 and 1312, and is selectively applied by closing the switch 1324. When the switch is open (FIG. 13) and no voltage is applied, the oil 1308 assumes a “drop” configuration, which diverges an image 1326 entering the electrowetting device 1300. When the switch 1324 is closed and a voltage is applied across the conductors 1304 and 1312, the oil 1308 assumes a convex configuration (FIG. 14) which converges the image 1426. The magnitude of the voltage is varied by adjusting the rheostat 1328, thereby modifying the convergence (focusing) of the image 1426.

This electrowetting focusing device 1300 is incorporated in the exemplary embodiment of a binocular display device 1500 as shown in FIG. 15, which includes a housing 1502 including an optical image generating device 1504, a reflective surface 1506, and the optional electrowetting device 1000. An image is provided by the optical image generating device 1504, which is focused by the electrowetting device 1300, is reflected by the surface 1506 and by the electrowetting device 1000 in the X and Y direction for presentation to the eye 1508. It should be appreciated that the electrowetting device 1300 may alternatively be positioned between the reflective surface 1506 and the electrowetting device 1000, or between the electrowetting device 1000 and the eye. A microcomputer 1507 may be coupled between the image receiving device 1504 and the reflective surface 1506 for determining necessary adjustments and providing adjusting the voltage applied to the electrowetting device 1000 and thereby modifying the angle of reflection in the X and Y direction.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A wearable display device comprising:
an image generating device for presenting an image; and
a first electrowetting device that reflects the image from the image generating device in a first direction and at an angle which is dependent upon a voltage magnitude applied to the first electrowetting device.

2. The wearable display device of claim 1 further comprising a second electrowetting device that reflects the image in a second direction orthogonal to the first direction and at an angle which is dependent upon a voltage magnitude applied to the second electrowetting device.

3. The wearable display device of claim 1 wherein the first electrowetting device reflects the image in both an “x” and a “y” direction.

4. The wearable display device of claim 1 wherein the first electrowetting device focuses the image.

5. The wearable display device of claim 1 wherein the first electrowetting device comprises:
a first fluid;
a second fluid that is hydrophobic; and
a reflective surface disposed between the first and second fluids.

6. The wearable display device of claim 1 further comprising an environmental sensor having an output that affects the voltage magnitude.

7. A binocular device comprising:
an image generating device for presenting an image;
a microcomputer for determining at least one of a misalignment and divergence of the image and assigning a value thereto; and
a first electrowetting device that reflects the image from the image generating device at an angle in response to the value.

8. The wearable display device of claim 7 further comprising a second electrowetting device that reflects the image in a second direction orthogonal to the first direction and at an angle which is dependent upon a voltage magnitude applied to the second electrowetting device.

9. The wearable display device of claim 7 wherein the first electrowetting device reflects the image in both an “x” and a “y” direction.

10. The wearable display device of claim 7 wherein the first electrowetting device focuses the image.

11. The wearable display device of claim 7 wherein the first electrowetting device comprises:
a first fluid;
a second fluid that is hydrophobic; and
a reflective material disposed between the first and second fluids.

12. The wearable display device of claim 7 wherein the microcomputer comprises an environmental sensor.

13. The binocular device of claim 7 wherein the first electrowetting device displays an image to an eye further comprises a second electrowetting device for displaying the image to another eye, wherein the image to one eye is aligned with the image to the second eye.

14. A method for aligning an image displayed by a wearable display device, comprising:
generating an image;
assigning a value to an amount of misalignment or divergence of the image; and
applying a first voltage having a magnitude dependent upon the value, thereby repositioning a fluid in a first electrowetting system to accomplish at least one of an aligning or focusing of the image.

15. The method of claim 14 further comprising applying a second voltage having a magnitude dependent upon the value, thereby repositioning a fluid in a second electrowetting system to accomplish at least one of an aligning or focusing of the image.

16. The method of claim 14 wherein the applying a first voltage comprises aligning the image in first direction and further comprising applying a second voltage to align the image in a second direction orthogonal to the first direction.

17. The method of claim 14 further comprising:
sensing an environmental parameter; and
modifying the magnitude of the voltage in response to the sensing.

18. The method of claim 14 further comprising:
receiving a test image by the image generating device;
measuring misalignment of the test image;
storing the misalignment;
receiving an actual image by the image generating device;
generating a signal based on the stored misalignment; and
adjusting, in accordance with the signal, the actual image to be generated to reduce the misalignment of the image.

19. The method of claim 14 wherein the value indicative of misalignment are determined by a plurality of environmental parameters, the method further comprising determining the current environmental parameter, and wherein the assigning step comprises assigning a magnitude of the voltage based on the current environmental parameter.

20. The method of claim 19 wherein the current environmental parameter includes one of temperature and humidity.
